(19) United States
(12) Patent Application Publication
(10) Pub. No.: US 2023/0403557 A1
(43) Pub. Date: Dec. 14, 2023

(54) Bluetooth Low Energy for Network Troubleshooting

(71) Applicant: CenturyLink Intellectual Property LLC, Broomfield, CO (US)

(72) Inventors: Shaun Hawkinson, St. Paul, MN (US); Kevin Lu, Bridgewater, NJ (US)

(73) Assignee: CenturyLink Intellectual Property LLC, Broomfield, CO (US)

(21) Appl. No.: 18/331,588

(22) Filed: Jun. 8, 2023

Related U.S. Application Data
(60) Provisional application No. 63/350,729, filed on Jun. 9, 2022.

(51) Int. Cl. H04W 12/069; H04L 9/30; H04L 9/14; H04W 12/50

(52) U.S. Cl. CPC H04W 12/069; H04L 9/30; H04L 9/14; H04W 12/50

(57) ABSTRACT

The present disclosure describes providing a system and method for providing remote servicing of a customer device over a secure short-range wireless communication network connection. The customer device may be configured to securely establish a secure short-range wireless network communication connection between the customer device and a mobile device associated with an authorized user. When the mobile device is communicatively coupled with a customer device, the user may be enabled to access various installation, configuration, troubleshooting, and/or settings changing services on the customer device via the secure short-range wireless communication channel.

### CROSS-REFERENCE TO RELATED APPLICATIONS

This application claims the benefit of U.S. Provisional Application No. 63/350,729 filed Jun. 9, 2022, entitled “Bluetooth Low Energy for Network Troubleshooting,” which is incorporated herein by reference in its entirety.

### BACKGROUND

Wireless communication is becoming more commonly used in applications where sensitive information is being transmitted between computing devices. Accordingly, devices that use wireless communication protocols may benefit from security features in transmitting sensitive data.

It is with respect to this general technical environment that aspects of the present technology disclosed herein have been contemplated. Furthermore, although a general environment is discussed, it should be understood that the examples described herein should not be limited to the general environment identified herein.

### SUMMARY

The present disclosure describes a system and method for providing remote servicing of a customer device over a secure short-range wireless communication network connection.

Accordingly, among other things, aspects of the present disclosure include a method for providing remote servicing of a customer device over a secure short-range wireless communication network connection, comprising: advertising, by the customer device, a unique identifier of the customer device over a short-range wireless communication network; receiving a request from a mobile device to initiate a connection to the customer device; in response to the request, exchanging pairing information with the mobile device; based on the pairing information, establishing a secure connection between the mobile device and the customer device; and performing an authentication method over the secure connection. In examples, the authentication method comprises: deriving a public key; advertising the public key to the mobile device; deriving a first authentication key using the public key, a stored private key, and the unique identifier of the customer device; receiving a second authentication key from the mobile device; and in response to determining that the first authentication key and the second authentication key match, allowing the mobile device read, write, or read-and-write access to a plurality of attributes in a storage system on the customer device related to servicing the customer device via the mobile device over the secure connection. Other aspects of the present application comprise systems and devices for performing such method.

Another aspect of the present application includes a method comprising: authenticating a user of a mobile device; obtaining a private key for the customer device via a first communication network; receiving an advertisement from the customer device over a second communication network, wherein the advertisement includes a unique identifier of the device; in response to identifying the customer device based on the unique identifier, initiating a connection to the customer device over the second communication channel; exchanging pairing information with the customer device; based on the pairing information, establishing a secure connection between the mobile device and the customer device; and performing an authentication method over the secure connection. In examples, the authentication method comprises: receiving a public key from the customer device; deriving a first authentication key using the public key, the unique identifier, and the private key; providing the first authentication key to the customer device; and receiving read, write, or read-and-write access to a plurality of attributes in a storage system on the customer device, wherein the plurality of attributes is related to servicing the customer device via the mobile device via the secure connection. Other aspects of the present application comprise systems and devices for performing such method.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates an example operating environment for implementing a system for providing remote servicing of a customer device over a secure short-range wireless communication network connection in accordance with an embodiment.

FIG. 2 is a block diagram illustrating an example flow of communications that may be exchanged for providing remote servicing of a customer device over a secure short-range wireless communication network connection in accordance with an embodiment.

FIG. 3 illustrates an example method for providing remote servicing of a customer device over a secure short-range wireless communication network connection in accordance with an embodiment.

FIG. 4 illustrates another example method for providing remote servicing of a customer device over a secure short-range wireless communication network connection in accordance with an embodiment.

FIG. 5 is a block diagram of an example communication system protocol stack according to an example.

FIG. 6 is a block diagram of a computing device with which one or more aspects of the disclosure may be implemented in accordance with an embodiment.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Various types of customer premises equipment (CPE) devices (herein referred to as customer devices), such as network gateway devices, when provisioned at a customer's premises, may, at various times, require servicing. For example, the customer device may need installation, configuration, and/or troubleshooting services to be performed for operating the device. Often, such services may be provided by a service technician, where the customer may schedule an appointment for the service, and a range of times may be specified for the appointment. Currently, the service may be performed inside the customer premises, where the service technician can access the device. Accordingly, the customer may be required to be at the premises during the specified range of time to allow interior access to the service technician. As can be appreciated, requiring interior access to the customer premises to service the customer device can not only be inconvenient for the customer and inefficient for the technician (e.g., time associated with gaining interior access to multiple premises and interacting with customers over a plurality of service calls; being restricted to a block of time in association with scheduled service call appointments), but can also expose customers and technicians to safety hazards, such as exposure to contagious diseases or other risks.

In order to address the above and other aspects, the present disclosure describes a customer device that comprises an application that uses a communication system to securely establish a secure short-range wireless network communication connection between the customer device and a mobile device associated with an authorized user. In an example, the communication system may operate to advertise a unique number associated with the customer device, which can reduce or eliminate ambiguity in determining which customer device to initiate a connection with if there are multiple customer devices in the vicinity, such as when the customer premises is a multi-dwelling unit (MDU) or where multiple customer premises are within close proximity, and multiple customer devices may be transmitting advertisements. In another example, the communication system may further operate to advertise additional information about the customer device (e.g., connection status information). When the mobile device is communicatively coupled with a customer device, the user may be enabled to access various installation, configuration, troubleshooting, and/or settings changing services on the customer device via the secure short-range wireless communication channel.

In an example, the user may be a service technician, and the communication system may enable the service technician to, via an application operating on the technician's mobile device (e.g., mobile phone, tablet), activate the customer device, check and/or adjust various settings and/or configurations, run various network diagnostic tests to assist the technician in diagnosing connectivity issues, and/or perform other services. For example, the service technician may be enabled to securely connect to and service the customer device from outside the customer premises via the mobile device. Accordingly, the service technician may not require interior access for performing various service calls. Among other conveniences for the customer and service technician, this can reduce or eliminate service call appointments that require interior access for the service technician and that require the customer to be at the premises for the service call. As mentioned above, this can further provide various efficiency and safety benefits.

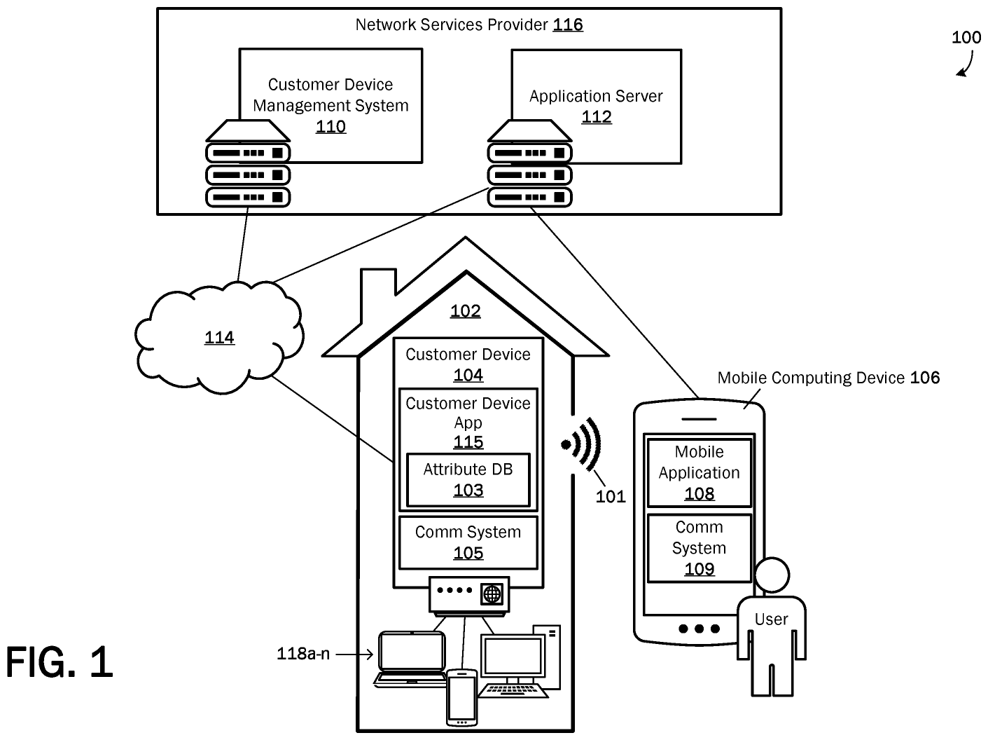

In other examples, the communication system may enable an application operating on a mobile device (e.g., mobile phone) associated with the customer to securely communicate with the customer device via the short-range wireless communication channel. For example, when the mobile device is communicatively coupled with the customer device, the customer can set a password, adjust various configurations and/or settings of the customer device, etc. These and other examples will be explained in more detail below with respect to FIGS. 1-6. It will be appreciated that the examples shown by the figures and described herein may be used across the various implementations described herein.

FIG. 1 illustrates an example operating environment 100 in which remote servicing of a customer device 104 over a secure short-range wireless communication network connection can be implemented according to an example. In the example shown in FIG. 1, the operating environment 100 includes a customer premises equipment (customer) device 104 implemented at a customer premises 102. The customer device 104 may be provided by or otherwise associated with a network services provider 116 that may provide the premises 102 with access to a broadband network 114 (herein referred to generally as network 114). For example, the network services provider 116 may be a provider of telecommunication services, data services, messaging services, etc., and the network 114 may include any one or more networks known in the art (e.g., wide area networks (WANs), local area networks (LANs), personal area networks (PANs), and/or the Internet). The network services provider 116 may provide fiber-optic cable, copper cable, and/or other physical links/circuits that enable customers to access the network 114 via the customer device 104. In some implementations, the customer device 104 may operate as a modem that connects a router and/or one or more computing devices 118a-n (generally, 118) to the network 114. In some implementations, the customer device 104 may further operate as a router. The various computing devices 118, for example, may include mobile devices, laptop computers, desktop computers, servers, gaming devices, set-top boxes, Internet-of-Things (IOT), smart devices, etc. The customer device 104 may operate to connect the computing devices 118 to the network 114 via one or a combination of communication transports provided by the network services provider 116.

The customer premises 102 may be a home (e.g., single-family residence, a multi-dwelling unit (MDU)), an enterprise such as, for example, a university, a business, a corporation, a government entity, or the like, or other location at which network access is desired. In various examples, such as when the customer premises 102 is an MDU or enterprise, a plurality of customer devices 104 may be implemented at the customer premises 102. In other examples, a plurality of customer devices 104 may be implemented at a plurality of customer premises 102 that may be within close proximity.

In some examples, the customer device 104 may operate to communicate with a customer device management system 110 via the network 114. For example, the customer device management system 110 may provide remote management of customer devices 104 over the network 114, which can include service activation and reconfiguration, remote subscriber support, firmware updates and configuration management, diagnostics and monitoring, etc.

The customer device 104 may include an operating system and one or more program modules suitable for running one or more applications. In an example, a customer device application 115 of the one or more applications may be or be included in a version of firmware stored in memory/storage on the customer device 104 capable of storing data, instructions, or other information that may be used by a processor to perform one or more of the aspects of the present disclosure. In some examples, the customer device application 115 may include an attribute database 103 that may operate to store data that can be exposed to another device via a short-range wireless communication (e.g., BLUETOOTH LOW ENERGY (BLE) protocol) connection. The data stored in the attribute database 103, for example, may include one or more services comprising a collection of characteristics. The characteristics may include various attributes, such as a data value, property, and/or configuration information, that may be transferred between the customer device 104 and another device (e.g., a mobile device).

According to an aspect, the customer device 104 may further include a communication system 105 that may operate to provide a communication interface between the customer device 104 and a remote mobile phone, tablet, or other mobile computing device (herein referred to as a mobile device 106) over a short-range wireless communication network 101. In some examples, the customer device application 115 may use the communication system 105 of the customer device 104 to exchange attribute database information with a mobile application 108 executing on a mobile device 106 via the short-range wireless communication network 101. The customer device application 115 may interface the communication system 105 via an application programming interface (API). In an example implementation, the communication system 105 of the customer device 104 and the communication system 109 of the mobile device 106 may include a BLE protocol stack that may utilize BLE technology to communicate over the short-range wireless network 101. For example, the communication systems 105, 109 may operate to utilize the BLE protocol stack to transfer data in accordance with a BLUETOOTH specification and BLE protocol. In other examples, other communication technologies are contemplated.

In one example, a user of the mobile device 106 may be a service technician. For instance, a service technician may use the mobile device 106 to establish a secure communication link/connection with the customer device 101 over the short-range wireless communication network 101. Via the secure connection, the service technician may be able to use the mobile application 108 to access various information about the customer device 104, configure the customer device 104, run various network diagnostic tests, diagnose network connectivity issues, troubleshoot connectivity or operational issues, etc. Aspects of the present disclosure can enable a service technician to perform various field service call-related services via the mobile device 106 without requiring access to an interior of the building in which the customer device 104 is positioned (e.g., inside of the customer premises 102). In examples, this may be particularly useful by reducing or eliminating a need for scheduling field service call appointments that require the customer to be at the customer premises 102 during a specified range of time to allow interior access to the network technician, thus improving service efficiency. In other examples, an increase in safety may be provided by minimizing a risk of exposing the network technician and/or customer to contagious diseases or other risks.

As shown in FIG. 1, the mobile application 108 may be in communication with an application server 112 that may operate to provide authentication and authorization for the user for enabling the mobile application 108 to authenticate itself with the customer device 104. The mobile application 108 may communicate with the application server 112 using a network other than the short-range wireless communication network 101. The application server 112 may include or may operate to access one or more databases that store authorization and authorization information for one or more users and one or more customer devices. In one example, the application server 112 may access or store login information (e.g., user identifiers (ID), passwords) associated with users that may be authorized to use the mobile application 108. In another example, the application server 112 may access or store customer device information (e.g., unique identifiers, private passcodes/keys) for the customer device 104. As will be described in further detail below, one or more private keys may be generated for the customer device 104, and may be provided to the customer device 104 during manufacture or in one or more firmware updates. The one or more private keys may additionally be provided to the mobile application 108 of an authorized user. In another example, the application server 112 may access or store authorization information associated with the customer device 104 (e.g., a list of users who have permission to access the customer device 104, a list of services associated with the customer device 104 that a user has permission to access, a list of customer devices a particular user has permission to access). In another example, the application server 112 may access or store scheduling information related to servicing the customer device 104 (e.g., appointment date/time information, customer information, location information, customer device unique identifier). In another example, the application server 112 may access or store additional or alternative information.

According to other examples, the mobile device 106 may be a mobile computing device associated with a customer of the customer premises 102. In this example, a customer version of the mobile application 108 may use the mobile communication system 109 to communicate with the customer device 104 over the short-range wireless network 101 for enabling the customer to, for example: access information about the customer device 104, make one or more configuration or settings changes to the customer device 104, or perform other actions authorized by the network services provider 116 to be performed by customers via the customer version of the mobile application 108.

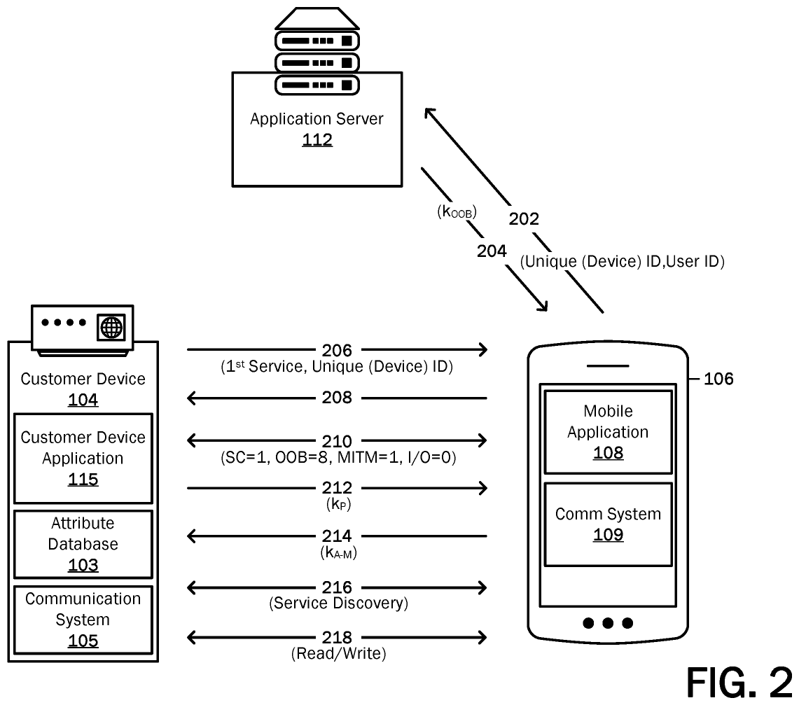

With reference now to FIG. 2, a block diagram of an example flow of generalized communications between the customer device 104, a mobile device 106, and the application server 112 is illustrated. For example, the communications may be exchanged to provide remote servicing of the customer device 104 over a secure short-range wireless communication network connection according to an example. As illustrated, a first communication 202 may be transmitted from the mobile device 104 to the application server 112. As used herein, ordinals like “first”, “second”, “third”, etc. are used for convenience and do not imply a required order of operations unless otherwise stated. The first communication 202 may include an authorization and authentication request. For example, user access to the mobile application 108 may be restricted to ensure the user of the mobile application 108 is authenticated and authorized to manage (e.g., access one or more services stored in the attribute database 103 on) the customer device 104 to which they are initiating a connection. In some examples, the user may be prompted to provide a passcode that may be verified for allowing the user to access the mobile application 108 on the mobile device 106. The first communication 202 may be transmitted to the application server 112 over a communication channel, such as a WIFI or a cellular network, for example. According to an example, the first communication 202 may include the unique identifier of the customer device 104 and a user identifier (ID) associated with the user of the mobile device 106. Information included in the first communication 202 may be used by the application server 112 to authorize and authenticate the user to ensure the user (e.g., based on the user ID) is authorized to manage the customer device 104 associated with the unique identifier. In some example implementations, the unique identifier includes a serial number (SN) of the customer device 104.

When a determination is made that the user is authorized to manage the customer device 104, the application server 112 may retrieve one or more secret or private passcodes/keys associated with the customer device 104. The private key, for example, may be stored in a database included in or communicatively coupled to the application server 112 in association with the customer device 104 based on the device's unique identifier, and may further be stored locally on the customer device 104.

In one example, the application server 112 may provide the private key to the mobile application 108 in a second communication 204. According to an aspect, the second communication 204 may be sent out-of-band (OOB) of the short-range wireless network 101 (e.g., BLE) communication frequency range. Thus, the private key may sometimes be referred to herein as an OOB key k_{OOB}. The mobile application 108 may operate to receive the second communication 204 including the OOB key k_{OOB}. In some examples, the mobile application 108 may be configured to cache the OOB key k_{OOB} for a limited duration. For example, for increased security, the mobile application 108 may be limited to cache the OOB key k_{OOB} for up to a predefined maximum time duration (e.g., 1 hour, 4 hours, 8 hours, 12 hours).

In some examples, the unique identifier of the customer device 104 included in the first communication 202 may be obtained from a third communication 206 received from the customer device 104 and may actually be received prior to the first communication 202. The third communication 206, for example, may be a first advertisement transmitted by the communication system 105 of the customer device 104. In some examples, the mobile device 106 may be within short-range wireless communication range of the customer device 104 when the mobile application 108 requests the OOB key k_{OOB} for the customer device 104 in the first communication 202. In other examples, the OOB key k_{OOB} may be obtained prior to when the mobile device 106 is within short-range wireless communication range of the customer device 104. For instance, the mobile application 108 may, prior to the service call, obtain the unique identifier of the customer device 104 from service call scheduling information, user input, etc.

According to an aspect, the OOB key k_{OOB} may additionally be stored in an encrypted form in firmware (e.g., customer device application 115) installed on the customer device 104. If a new OOB key k_{OOB} is generated by the application server 112 for the customer device 104, the new OOB key k_{OOB} may be stored by the application server 112 in association with the customer device 104 and a firmware upgrade version. The firmware upgrade version including the new OOB key k_{OOB} may be loaded onto the customer device 104 and stored in an encrypted form in the customer device's firmware, for example, during a firmware upgrade. Additionally, if a new version of the OOB key k_{OOB} has been generated for the customer device 104, the mobile application 108 may operate to receive the original and the new versions of the OOB key k_{OOB}. In one illustrative example, the OOB key k_{OOB} may be a 16-character, 32-character, or 64-character private string.

According to an example, the first advertisement (e.g., third communication 206) may be associated with a first service of one or more services included in the attribute database 103 that may be exposed by the customer device 104. The one or more services may define information (e.g., characteristics) related to various parameters/attributes of the customer device 104 that may be read and/or modified by the mobile application 108 after establishing a connection. According to an example implementation, the attributes of the customer device 104 may be related to servicing the customer device 104 via the mobile application 108 over the short-range wireless network 101.

For example, the first service may define data related to various information about the customer device 104. The first service may sometimes be referred to herein as a data service. The data service may include various characteristics, which may be designated as read only, write only, read or write, broadcast, notifiable, etc. Example characteristics may include, for example: the unique identifier (e.g., SN) of the customer device 104, a user ID of a (connected, last-connected) user, a software version of the firmware (e.g., customer device application 115) operating on the customer device 104, a MAC address of the customer device 104, a WAN status characteristic, a small form-factor pluggable module detection characteristic, a digital subscriber line (DSL) interface connection status characteristic, an asynchronous transfer mode (ATM) interface connection status characteristic, a packet transfer mode (PTM) interface connection status characteristic, one or more ethernet interface connection status characteristics, a DSL channel downstream transfer rate characteristic, a DSL channel upstream transfer rate characteristic, an Internet Protocol (IP) address characteristic, an ethernet link packets sent characteristic, an ethernet link received characteristic, an ethernet link uptime characteristic, a walled garden state characteristic, a point-to-point (PPP) username characteristic, and a PPP password characteristic. Other characteristics are possible and are within the scope of the present disclosure.

The first advertisement (e.g., third communication 206) may include a plurality of advertising data elements, including information about the customer device 104. According to an example, one advertising data element in the first advertisement 302 may include a unique identifier of the customer device 104. For instance, unlike a model number that may normally be advertised by a device, the unique identifier advertised by the customer device 104 may uniquely identify the customer device 104 amongst a plurality of customer devices that may be advertising within range of the mobile device 106. As mentioned above, in some examples, the unique identifier may include a serial number (SN) of the customer device 104. In an example implementation, the unique identifier may include or indicate the model number of the customer device 104. In some examples, the unique identifier may be included in a scan response if the first advertisement has a length limitation.

According to an example implementation, another advertising data element in the first advertisement may include other information about the customer device 104. For example, the customer device 104 may be configured to include network connection status information (e.g., WAN status), cloud device management system connection status information (e.g., whether the customer device 104 is active in the cloud-based customer device management system 110). The mobile application 108 may be configured to use the other advertisement information to make a decision about whether to continue connecting to the customer device 104. As an example, in some cases, if the first advertisement indicates that the customer device 104 is active in the cloud customer device management system 110, a determination may be made for one or more device management tasks (e.g., related to service activation and reconfiguration, remote subscriber support, firmware updates and configuration management, or diagnostics and monitoring) to be performed by the cloud customer device management system 110 over another communication channel (e.g., the network 114). Other example device-related information may be advertised by the customer device 104 in the third communication 206.

According to an example, the customer device 104 may operate to advertise the third communication 206 at a first advertising rate. The first advertising rate, for example, may be used for the first advertisement from boot time to a duration after the customer device 104 has obtained a WAN Internet Protocol (IP) address. After the duration, the communication system 105 may operate to transmit/advertise the first advertisement at a second advertising rate. As an example, the first advertising rate may include a frequent advertising interval (e.g., 500 ms) and the second advertising rate may include a normal advertising interval (e.g., 5000 ms). In some examples, a temporary frequent advertising duration parameter may be applied. For instance, the temporary frequent advertising duration may be set to zero (0) by default, and may be selectively set to a positive integer, such as when a pairing button on the customer device 104 or another pairing option is selected. When the temporary frequent advertising duration is set to a positive integer, the communication system 105 may operate to remain advertising at the first advertising rate without changing to the second advertising rate for the duration of the parameter, which may indicate a number of seconds remaining in the temporary frequent advertising duration.

With reference still to FIG. 2, the third communication 206 may be received by the mobile application 108. For example, the mobile device 106 on which the mobile application 108 is operating may be within short-range communication range of the customer device 104 and may operate to scan for advertisement data broadcasts. According to an example, the customer device 104 may be located inside the customer premises 102 and the user of the mobile device 106 may be exterior to the customer premises 102. In other examples, the user may be inside the customer premises 102. As can be appreciated, by advertising the unique identifier of the customer device 104, the mobile application 108 or the user can determine the correct customer device 104 with which a connection is intended. In an example, the user may be a service technician, and the mobile application 108 may further operate to access and provide information to the user in association with service calls that the service technician is scheduled to complete, such as location information (e.g., address, global positioning system (GPS) coordinates) of the customer premises 102, the unique identifier of the customer device 104 at the customer premises 102, and other relevant information (e.g., customer name, time of a scheduled appointment). In some examples, the mobile application 108 may further access and provide location information of the customer device 104 at the customer premises 102. For example, the customer device location information may include an indication of an exterior wall of the customer premises 102 that may be nearest to the customer device 104 located inside the premises 102. This service call-related information may herein be referred to as service call information.

In some examples, the mobile application 108 may operate to automatically select to initiate a connection with the customer device 104 based on one or more pieces of the service call information. For instance, the mobile device 106 may be equipped with a GPS system or another location determining system, and when a determination is made that the mobile device 106 is at the customer premises 102 of a scheduled service call (e.g., based on the location information), and when the unique identifier of the customer device 104 advertised in the first advertisement matches the unique identifier of the customer device 104 included in the service call information, the mobile application 108 may operate to initiate a connection with the customer device 104. In other examples, the unique identifier included in the first advertisement may be displayed on a screen/display of the mobile device 106, and the user may provide an input to selectively initiate the connection with the customer device 104. As can be appreciated, the unique identifier included in the first advertisement may clearly identify the customer device 104 for enabling an accurate selection of the intended customer device 104 if there are multiple customer devices 104 in the vicinity that may be transmitting the first advertisement, which can increase data security against threats, such as eavesdropping and Man in the Middle (MITM) attacks, and improve efficiency of connecting to the customer device 104.

According to an example, responsive to a determination to connect to the customer device 104, the mobile application 108 may initiate a connection with the customer device 104. As depicted in FIG. 2, the mobile application 108 may use the communication system 109 on the mobile device 106 to send a fourth communication 208, which may include a connection request to the customer device 104 to build a link layer (LL) connection. Over the LL connection, pairing request and response messages (sometimes referred to herein as a fifth set of communications 210) may be exchanged. For example, the fifth set of communications 210 may include an exchange of pairing features of the customer device 104 and the mobile device 106 for selecting an encryption and authentication method for pairing. The fifth set of communications 210 may include security feature information, such as Input/Output (IO) capabilities, OOB authentication data capabilities, requirements for MITM protection, etc.

According to an example, the customer device 104 may be configured to require secure connection pairing (e.g., as opposed to legacy pairing). For example, in an authorization requirements field included in the pairing request and response messages, a Secure Connection (SC) bit may be set, which may indicate that the customer device 104 and the mobile device 106 support and require LE Secure Connections.

According to another example, the customer device 104 and the mobile device 106 may further require and support exchanging authentication data through an OOB method. Accordingly, an OOB data flag included in the fifth set of communications 210 may be set by the customer device 104 and the mobile device 106 to indicate OOB reception capability.

According to another example, the customer device 104 and the mobile device 106 may further require MITM protection. Thus, an MITM flag included in the authorization requirements field may be set, which may indicate the requirement for MITM protection.

According to another example, the customer device 104 may be configured to indicate that it does not have input or output capabilities. For example, an IO capability flag may be set by the customer device 104 to include a value indicating that the customer device 104 does not have a display or keyboard. Accordingly, the mobile device 106 and customer device 104 may agree (e.g., be required) to use Just Works pairing method. The Just Works pairing method, for example, may enable the mobile device 106 and the customer device 104 to pair with encryption but without authenticating, and may enable the customer device application 115 to determine an authentication method. Accordingly, the customer device application 115 and the mobile application 108 may operate to perform a custom authentication method described herein.

As depicted in FIG. 2, after agreeing on encryption and authentication methods, an encrypted tunnel may be established between the mobile device 106 and the customer device 104. Over the encrypted tunnel, authentication information may be passed between the mobile device 106 and the customer device 104 in a sixth communication 212 and a seventh communication 214. For example, the customer device 104 may be configured to generate a public key k_{P} and advertise the public key k_{P} to the mobile device 106 in the sixth communication 212. In some examples, the sixth communication 212 may additionally include the unique identifier of the customer device 104. In some examples, the public key k_{P} may be included in a manufacturer specific field of the sixth communication 212. For increased security, the customer device application 115 may be configured to repeatedly generated a new public key k_{P} according to a predetermined frequency (e.g., every minute, every 2 minutes, every 5 minutes). In an example, the public key k_{P} be an 8-character, 16-character, or 32-character random string.

In some examples, the last N digits of the public key's random string may indicate a version of the private/OOB key k_{OOB} to use (e.g., 01, 02, 42). For example, an example public key k_{P} “XXXXXX01” may indicate that the mobile application 108 should use a first version (01) of the customer device's OOB key k_{OOB} that may be received from the application server 112 (e.g., in the second communication 204). As mentioned above, upgraded firmware versions may include a newly-generated private key k_{OOB} that may be generated and stored by the application server 112 and loaded onto the customer device 104 in a firmware upgrade.

According to an aspect, the mobile application 108 may receive the sixth communication 212 and use the authentication information included in the sixth communication 212 to derive an authentication key k_{A-M} according to an authentication key generation algorithm. In an example implementation, the mobile application 108 may read and use the unique identifier of the customer device 104 and the public key k_{P} from the sixth communication 212 to derive the authentication key k_{A-M}. For example, the authentication key k_{A-M} may be included in the seventh communication 214) and used by the customer device application 115 to determine whether to continue the secure connection with the mobile application 108, as described in further detail below.

According to an example, the customer device application 115 may operate to use the same authentication key generation algorithm to derive a local version of the authentication key k_{A-CD}. The locally derived authentication key k_{A-CD} may be compared against the application's authentication key k_{A-M} for determining whether to authenticate the mobile application 108 for continuing the secure connection with the mobile application 108. For example, when a determination is made that the authentication keys k_{A-CD},k_{A-M} match, the customer device application 115 may determine to continue the connection, where communications between the customer device 104 and the mobile application 108 may be encrypted and decrypted using the authentication keys authentication keys k_{A-CD},k_{A-M}.

In some examples, the authentication key generation algorithm may not be used by the mobile application 108, such as when operating on a customer's mobile device 106. For example, a customer-facing mobile application 108 may not implement the authentication key generation algorithm to derive the authentication key k_{A-M}, nor store the private/OOB key k_{OOB} in code. Alternatively, in some examples, the customer-facing mobile application 108 may be required to contact the application server 112 to transmit the unique identifier and public key k_{P} and, after proper user authentication and authorization has been performed, receive the authentication key k_{A-M}.

In other examples, a technician-facing mobile application 108 (the mobile application 108 when operating on a technician's mobile device 106) may be configured to derive the authentication key k_{A-M} by combining the unique identifier, the public key k_{P}, and the private/OOB key k_{OOB}. In deriving the authentication key k_{A-M}, the mobile application 108 may determine the version of the private/OOB key k_{OOB} to use (e.g., based on the last N characters of the advertised public key k_{P}), where other versions of the private/OOB key k_{OOB} may be included in the customer device firmware (e.g., customer device application 115).

In some examples, the authentication key generation algorithm may further be configured to concatenate the private/OOB key k_{OOB}, the unique identifier, and the advertised public key k_{P} and then use the concatenated data as an input to a checksum algorithm (e.g., Secure Hash Algorithm (SHA)-256). The authentication key generation algorithm may be further operative to run the checksum algorithm and truncate the generated hash to a first N (e.g., 16, 32, or 64) characters.

The mobile application 108 may further operate to convert the user ID of the user of the mobile application 108 to a hexadecimal format and append the user ID to the generated authentication key k_{A-M}. Additionally, the mobile application 108 may include the authentication key k_{A-M} and appended user ID in a write request included in the seventh communication 214. The write request, for example, may be associated with a writable characteristic of one or more characteristics included in the first service included in the attribute database 103 exposed by the customer device application 108. According to an example implementation, the seventh communication 214 may include a request to write the authentication key k_{A-M} and appended user ID to the user ID characteristic parameter included in the data service.

According to an example implementation, the customer device application 115 may operate to receive the seventh communication 214, and read and split the customerData/UserID parameter value into the mobile application's authentication key k_{A-M} and user ID. The customer device application 115 may then compare the mobile application's authentication key k_{A-M} to the locally derived authentication key k_{A-CD}. In an example, the customer device application 115 may compare the first 32 bytes that were written to the customerData/UserID parameter to the expected (locally derived) authentication key k A_{A-CD}. If the mobile application's authentication key k_{A-M} and the customer device's authentication key k_{A-CD} do not match, the customer device application 115 may operate to drop the connection with the mobile application 108. Else, if the mobile application's authentication key k_{A-M} and the customer device's authentication key k_{A-CD} do match, the first 32 bytes may be stripped from the user ID parameter value, where the remaining bytes may be converted to ASCII and saved in the appropriate parameter of the attribute database 103, and the connection may be allowed to continue. In an example, the communications transmitted between the customer device 104 and the mobile device 106 may be encrypted and decrypted using the verified authentication key k_{A-M}.

In some examples, prior to performing read and write operations, a services discovery process may be performed, where various discovery messages may be included in an eighth set of communications 216 communicated between the customer device 104 and the mobile device 106. For example, the customer device application 115 may inform the mobile application 108 of the one or more services hosted by the attribute database 103 on the customer device 104. In some examples, the customer device application 115 may operate to automatically advertise one or more services in the attribute database 103. For instance, the advertisements may be broadcast at a frequent advertising rate, such as the frequent advertising interval described above (e.g., 500 ms). In other examples, the customer device application 115 may be configured to provide an indication of one or more services in the attribute database 103 in response to receiving a service discovery request from the mobile application 108. For instance, the customer device application 115 may respond with advertisements of one or more of the available services, where each service may comprise a collection of characteristics defining data values that may be transferred between the customer device 104 and the mobile application 108 to provide information about the customer device 104 and/or to perform a particular servicing function (e.g., activation, diagnostic testing, configuration updates) to the customer device 104 via the mobile application 108.

According to an example implementation, the advertised services may include a diagnostics service, where the diagnostics service may include various characteristics that may be read or written to for performing various troubleshooting operations, such as ping and speed test operations, viewing and/or adjusting various configuration settings, etc. Example characteristics that may be included in the diagnostics service may include, for example: the unique identifier of the customer device 104 characteristic; a reboot characteristic; a factory reset characteristic; a release and renew IP address characteristic; a reset PPP credentials characteristic; for ping testing: a ping size characteristic, a number of ping repetitions characteristic, a ping diagnostics state characteristic, a ping success count characteristic, a ping failure count characteristic, a ping average response time characteristic, a ping maximum response time characteristic, and a ping minimum response time characteristic; and for upload speed testing and for download speed testing: a uniform resource locator (URL) characteristic, a file length characteristic, a time duration characteristic, a number of connections characteristic, a diagnostics state characteristic, a maximum number of connections characteristic, a test bytes sent under full loading characteristic, a total bytes sent under full loading characteristic, a period of full loading characteristic, and a latency characteristic. Other characteristics are possible and are within the scope of the present disclosure.

According to another example implementation, the advertised services may include a passive optical network (PON) data service. The PON data service may include various characteristics that may be read or written to for exposing various counters for the customer device's PON interface to a requesting device. Example characteristics that may be included in the PON data service may include, for example: the unique identifier of the customer device 104 characteristic, a status of the optical interface characteristic, a last change characteristic, an optical signal level characteristic, a lower optical threshold characteristic, an upper optical threshold characteristic, a transmit optical level characteristic, a lower transmit power threshold characteristic, an upper transmit power threshold characteristic, a bit-interleaved parity (BIP) errors received count characteristic, a bytes sent count characteristic, a bytes received count characteristic, an errors sent count characteristic, an errors received count characteristic, a discards sent count characteristic, and a discards received count characteristic. Other characteristics are possible and are within the scope of the present disclosure. Moreover, other services may be included in the attribute database 103 and are within the scope of the present disclosure.

In some examples, after discovering a service, characteristics discovery messages may be exchanged between the mobile application 108 and the customer device application 115 to inform the mobile application 108 about the characteristics defined in a service. For example, in response to a request from the mobile application 108, the customer device application 115 may respond with the service's characteristics, their associated handles, and other information. In some examples, a characteristic may comprise one or more characteristic descriptors that may provide additional information about the characteristic. After discovering service characteristics, a characteristic descriptors discovery process may be performed, where various descriptor discovery messages may be exchanged between the mobile application 108 and the customer device application 115 to provide the mobile application 108 with a list of descriptors, their handles, and other information.

A ninth set of communications 218 depicted in FIG. 2 represent a communication of various commands, such as read or write commands in association with values of one or more service characteristics. For example, a read request may operate to initiate a transfer of data from the attribute database 103 to the mobile application 108. A write request, for example, may initiate a change to a value of a characteristic stored in the attribute database 103. For example, such read and write operations in association with various characteristics defined in one or more services included in the attribute database 103 may enable the service technician to service the customer device 104 from outside the customer premises 102 and, in some examples, not require interior access for performing various service calls. For instance, writing a value to some characteristics may initiate an action to be performed on the customer device 104. As an example, a reboot, a factory reset, a firmware update, a password reset, and/or other actions may be performed by the customer device application 115 in response to a request from the mobile application 108 to write a value to a reboot, factory reset, release renew, and/or reset PPP credentials characteristic. Other example actions that may be performed by the customer device application 115 responsive to a read or write request received from the mobile application 108 are possible and are within the scope of the present disclosure.

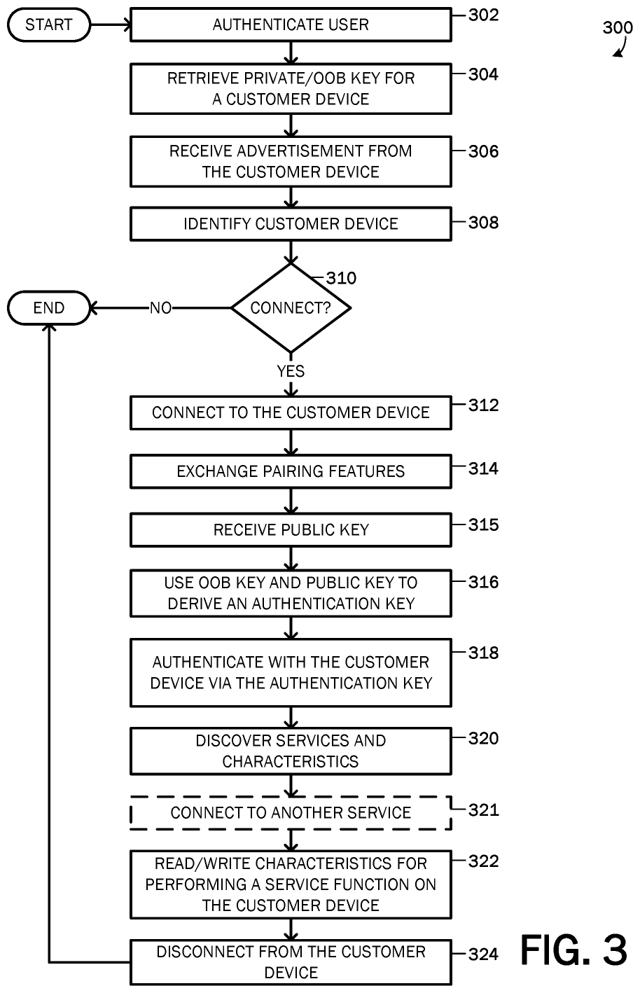

With reference now to FIG. 3, an example method 300 of operations for providing remote control of a customer device (e.g., such as customer device 104) via a mobile application (such as mobile application 108) over a secure short-range communication channel is shown in accordance with an embodiment. For example, one or more of the operations may be performed by the mobile application 108 using the communication system 109 operating on a mobile device 106. At OPERATION 302, a user of the mobile device 106 may be authenticated to use the application 108. For example, the user may be a service technician using a technician-facing mobile application 108 or a customer using a customer-facing mobile application 108. The user, for example, may be prompted to provide an input of credentials that may be checked to verify that user's identity and permissions that the user may have for utilizing the mobile application 108.

At OPERATION 304, a one or more private keys k_{OOB} associated with the customer device 104 may be obtained from the application server 112. In an example, in an OOB communication, (e.g., via a communication channel other than a BLE communication channel), an authorization and authentication request, which may include the unique identifier of the customer device 104 and the user ID of the user, may be transmitted by the mobile application 108 to the application server 112. Upon authentication of the user, the application server 112 may determine whether the user is authorized to manage the customer device 104. When a determination is made that the user is authorized, one or more private keys k_{OOB} associated with the customer device 104 may be obtained and provided to the mobile application 108. In some examples, the mobile application 108 may cache the private key(s) k_{OOB} for a limited time (e.g., a maximum of 4 hours, 8 hours, 12 hours).

At OPERATION 306, a first advertisement may be transmitted by the customer device and received by the mobile device 106. For example, the mobile device 106 may be within short-range wireless communication range of the customer device 104, and the mobile application 108 may be in a scanning state, where it may listen for advertisements. The mobile application 108 may receive the first advertisement, which may include information for about the customer device 104. According to an aspect, the first advertisement may include, in addition to other information, the unique identifier of the customer device 104.

At OPERATION 308, the customer device 104 may be identified based on the device's unique identifier. In some examples, the unique identifier of the customer device 104 may be displayed in a list of advertising devices, and the user may identify the customer device 104 based on the displayed unique identifier. In other examples, the customer device 104 may be automatically identified by the mobile application 108 based on the unique identifier. In other examples, additional information, such as location information, schedule information, etc., may be used in addition to the unique identifier for identifying the customer device 104.

At DECISION OPERATION 310, a determination may be made about whether to connect to the customer device 104. In one example, the determination may be made based on whether a selection made by the user to connect to the customer device 104 is received. In another example, the determination may be based on whether the unique identifier matches a unique identifier included in service call scheduling information that may include unique identifiers of devices that the service technician may be scheduled to service. In another example, the determination may be based at least in part on other information associated with the customer device 104, for example, that may be included in the advertisement data. As an example, the other customer device 104 information may include network connection status information (e.g., WAN status), cloud device management system connection status information (e.g., whether the customer device 104 is active in the cloud customer device management system 110), or other information. When a determination is made to not connect to the customer device 104, the method 400 may end. Alternatively, when a determination is made to connect to the customer device 104, at OPERATION 312, the mobile application 108 may enter a connection state and transmit a connection request message to the customer device 104 to establish an LL connection. For example, the mobile application 108 may operate as a LL primary and the customer device 104 may operate as a LL secondary for performing various connection events.

At OPERATION 314, a pairing feature exchange may be performed, where the mobile application 108 and the customer device 104 may exchange authentication requirements, Input/Output (IO) capabilities, and other information in pairing request and response messages to determine an encryption and authentication method to use. According to an example, the mobile application 108 and the customer device 104 may be configured to include information in the pairing request and response messages that may cause the mobile application 108 and the customer device 104 to select to use secure connection pairing (e.g., as opposed to legacy pairing) with MITM protection using a private key obtained in an OOB connection without authentication. For example, the pairing response message from the customer device 104 may indicate that the customer device 104 does not have IO capabilities for authentication.

At OPERATION 315, an encrypted tunnel may be established over the LL connection using an agreed-upon encryption method. According to an example, the mobile application 108 may receive a public key k_{P} derived and advertised by the customer device 104 over the LL connection.

At OPERATION 316, an authentication key k_{A-M} may be derived by the mobile application 108 using an authentication key generation algorithm. In one example implementation, the authentication key generation algorithm may instruct the mobile application 108 to determine a version of the private/OOB key k_{OOB} to use. In some examples, the public key k_{P} may include an indication of a version of the private/OOB key k_{OOB} to use. The mobile application 108 may be further instructed to concatenate the customer device's unique identifier, the public key k_{P}, and the private/OOB key k_{OOB} and use the concatenated data as an input to a checksum algorithm (e.g., Secure Hash Algorithm (SHA)-256). In some examples, if the private/OOB key k_{OOB} for the customer device 104 was not been previously obtained (e.g., at OPERATION 304), or if the private/OOB key k_{OOB} was previously obtained but is no longer cached (e.g., the maximum cache time for the private/OOB key k_{OOB} has expired), the mobile application 108 may further obtain the private/OOB key k_{OOB} as described above.

According to an example, the authentication key k_{A-M} may be determined to be a first N (e.g., 16, 32, 64) characters of the resulting hash. According to an aspect, the mobile application 108 may be further instructed to append the user ID to the authentication key k_{A-M} and, at OPERATION 318, write the authentication key k_{A-M} and user ID to a writable parameter of a message transmitted to the customer device 104. For example, when the message is received by the customer device 104 and the authentication key k_{A-M} is verified by comparing the authentication key k_{A-M} to an authentication key k_{A-CD} derived by the customer device 104 using the same authentication key generation algorithm, the mobile application 108 may be authenticated and the connection may be allowed to continue. The mobile application 108 and the customer device application 115, for example, may continue to exchange messages over the short-range wireless communication network 101 and use the authentication keys k_{A-M},k_{A-CD} to encrypt and decrypt the messages.

At OPERATION 320, a series of discovery messages may be exchanged. For example, the mobile application 108 may receive one or more advertisements of one or more services defined in the attribute database 103 on the customer device 104. In some examples, the mobile application 108 may request and receive additional service information (e.g., service UUIDs, characteristics and associated UUIDs, characteristic descriptors and associated UUIDs) from the customer device 104. As described above, the one or more services may include a customer device diagnostics service, a PON data service, and/or other services. In some examples, an indication of the one or more services may be displayed on the mobile device 104, and a selection to connect to another service may be made at optional OPERATION 321.

At OPERATION 322, the mobile application 108 may perform a read operation or a write operation to perform a servicing task associated with the customer device 104 via the mobile device 106. For example, a read operation may include sending a read request message to the customer device 104 in association with reading a value of an attribute (e.g., characteristic) stored in the attribute database 103. In response, the customer device application 115, may provide the requested attribute value. As an example, the mobile application 108 may request a value corresponding to an average ping response time of the customer device 104, which may be useful information to the user servicing the customer device 104. As another example, a write operation may include sending a write request message to the customer device 104 in association with writing a value to an attribute (e.g., characteristic) stored in the attribute database 103. In response, the customer device application 115 may write the requested value to the corresponding attribute (e.g., characteristic) in the attribute database 103. An indication that the write operation has been performed may be communicated to the mobile application 108. Accordingly, the read and write operations communicated over the secure short-range communication channel may enable the service technician to service the customer device 104 from outside the customer premises 102 and, in some examples, not require interior access for performing various servicing tasks associated with the customer device 104, such as reading various connection status values, rebooting or initiating a factory reset of the customer device 104, initiating and reading values of a speed test, initiating and reading values of a ping test, resetting a password, etc. OPERATIONS 321-322 may continue until the mobile application 108 is disconnected from the customer device 104 at OPERATION 324.

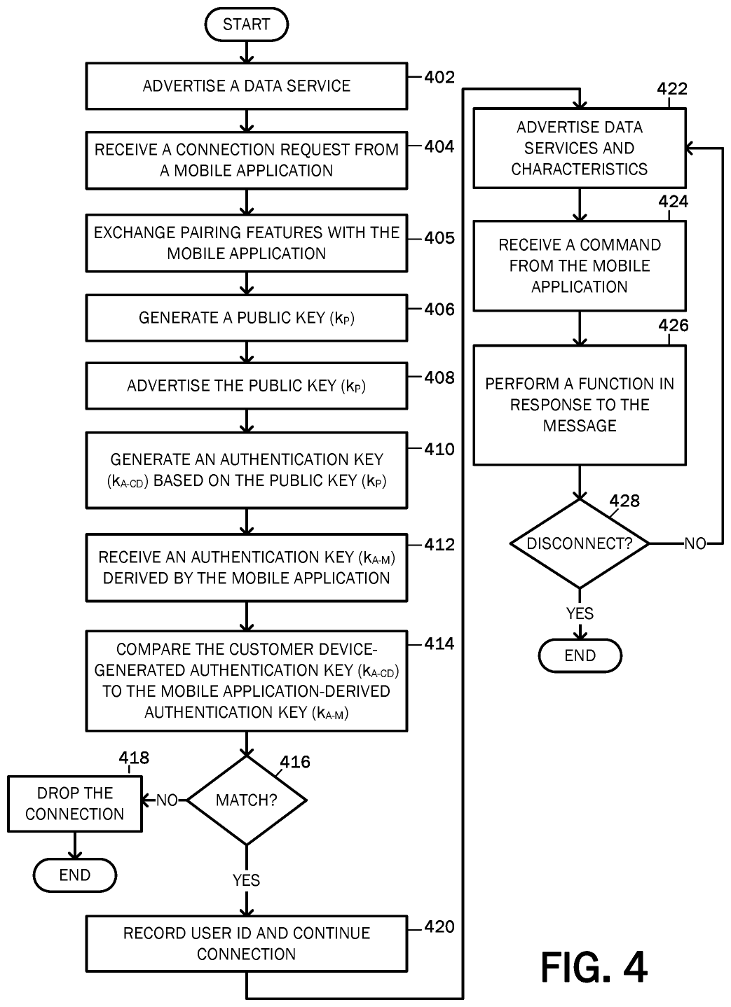

With reference now to FIG. 4, an example method 400 of operations for providing remote customer device service management over a secure short-range wireless communication channel in accordance with an embodiment is depicted. For example, the operations may be performed by the customer device application 115 using the communication system 105 operating on the customer device 104. At OPERATION 402, a first advertisement may be transmitted. According to an aspect, the first advertisement may be associated with a first service that may include a collection of data and associated behaviors. According to an aspect, the customer device 104 may be configured to include the unique identifier of the customer device 104 in the first advertisement. For example, the unique identifier may be used by the mobile application 108 operating on a mobile device 104 or a user of the mobile application 108 to easily and accurately identify the customer device 104 with which to connect. Other information about the customer device 104 may be included in the first advertisement. According to an example, the customer device application 115 may transmit the first advertisement at a frequent advertising interval (e.g., 500 ms) from boot time to a duration after the customer device 104 has obtained a WAN Internet Protocol (IP) address. After the duration, the customer device application 115 may transmit/advertise the first advertisement at a normal, longer advertising interval (e.g., 5000 ms).

At OPERATION 404, a connection request message from the mobile application 108 may be received. For example, a selection may be made by the mobile application 108 or received by the mobile application 108 to connect to the customer device 104. Thus, the mobile application 108 may initiate a connection with the customer device 104 by transmitting a connection request message. In response, the customer device application 115 and the mobile application 108 may exchange pairing feature information at OPERATION 405. In an example, the customer device application 115 may specify to use a secure connection with MITM protection and OOB pairing. Additionally, the customer device application 115 may indicate that it does not have IO capabilities for authentication, which may cause the mobile application 108 and the customer device application 115 to select the Just Works pairing procedure. Accordingly, the mobile application 108 and the customer device application 115 may perform an application-defined authentication method via an encrypted tunnel.

For example, at OPERATION 406, a public key k_{P} may be generated and then advertised by the customer device 104 at OPERATION 408. For example, the public key k_{P} may be advertised to the mobile application 108, which may use the public key k_{P} and other information to derive an authentication key to authenticate with the customer device 104. In some examples, a new public key k_{P} may be continually generated (e.g., every minute, every 2 minutes, every 5 minutes). In some examples, the public key k_{P} may indicate a version of a private/OOB key k_{OOB} to use (e.g., multiple private/OOB keys k_{OOB} may be derived for the customer device 104 in association with firmware updates).

At OPERATION 410, an authentication key k_{A-CD} may be generated locally using an authentication key generation algorithm. For example, the authentication key generation algorithm may be a same authentication key generation algorithm used by the mobile application 108 to derive a matching authentication key k_{A-M}. According to an example, the authentication key generation algorithm may instruct the customer device application 115 to concatenate the customer device's unique identifier, the current public key k_{P}, and the private/OOB key k_{OOB} stored by the customer device 104. The customer device application 115 may further use the concatenated data as an input to a checksum algorithm. According to an example, the authentication key k_{A-CD} may be determined to be a first N (e.g., 16, 32, 64, etc.) characters of the resulting hash.

At OPERATION 412, a message may be received from the mobile application 108 including the mobile application-derived authentication key k_{A-M}. In some examples, the authentication key k_{A-M} may be included in a request to write the authentication key k_{A-M} and additional data to a writable characteristic of the first service. In an example implementation, the additional data may include the mobile device user's user ID, where the user ID may be in hexadecimal format and appended to the mobile application-derived authentication key k_{A-M}. The resulting byte array may be received by the customer device application 115 and, at OPERATION 414, analyzed to determined whether to authenticate the mobile application user. At OPERATION 414, the customer device 104 may split the byte array into the mobile application's authentication key k_{A-M} and the user ID and compare the mobile application's authentication key k_{A-M} against the locally-derived authentication key k_{A-CD}.

At DECISION OPERATION 416, a determination may be made as to whether the authentication keys k_{A-M}, k_{A-CD} match. When a determination is made that the authentication keys k_{A-M}, k_{A-CD} do not match, the connection may be dropped at OPERATION 418. Alternatively, when a determination is made that the authentication keys k_{A-M}, k_{A-CD} do match, at OPERATION 420, the secure connection between the mobile application 108 and the customer device application 115 may allowed to continue, where the authentication keys k_{A-M}, k_{A-CD} may be used to encrypt and decrypt communications transmitted between the mobile application 108 and the customer device 104 over the short-range wireless communication network 101. Additionally, in some examples the user ID may be converted to ACII format and saved in the appropriate parameter of the data model (first service in the attribute database 103).

At OPERATION 422, when the mobile application 108 is connected to the first service, one or more other services included in the attribute database 103 may be advertised. For example, the customer device application 115 may be configured to advertise the one or more other services at a frequent advertising rate. Further, additional messages may be communicated between the mobile application 108 and the customer device application 115, where information about characteristics, characteristic descriptors, and associated handles (e.g., UUIDs) of an advertised service may be communicated to the mobile application 108.

At OPERATION 424, an incoming command may be received from the mobile application 108 in relation to a characteristic. For example, the command may be received as a read operation, where data associated with the characteristic may be requested by the mobile application 108, and the customer device application 115 may be provided to the mobile application 108 over the secure connection at OPERATION 426. Or, in another example, the command may be received as a write operation, where a value of the characteristic may be received from the mobile application 108, and the customer device application 115 may be configured to write the value to the characteristic in the attribute database 103 at OPERATION 426. For instance, writing the value to the characteristic may act as a flag, which may instruct the customer device application 115 to transmit a ping message to a host.

OPERATIONS 422-426 may continue to be performed until the mobile application 108 is no longer connected to the customer device. For example, at DECISION OPERATION 428, a determination may be made as to whether the mobile application 108 has been disconnected from the customer device 104. When a determination is made that the devices are still connected, the method 400 may return to OPERATION 422. Or, when a determination is made that the devices are not connected, the customer device application 115 may cease advertising its services and the method 400 may end.

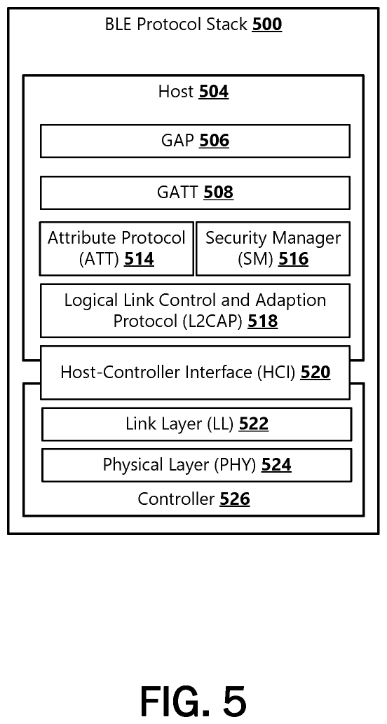

FIG. 5 is a block diagram of an example BLE protocol stack 500 that may be included in the communication systems 108, 105 of the mobile device 106 and the customer device 104 according to an example. As illustrated, the BLE protocol stack 500 includes a controller stack 526 operable to process a wireless device interface, and a host stack 504 operable to process high level data.

The controller stack 526 may be implemented by using a communication module that may include a Bluetooth wireless device, for example, a processor module that may include a processing device such as a microprocessor. The host stack 504 may be implemented as part of an OS operated on a processor module or may be implemented as instantiation of a package on the OS. In some examples, the controller stack and the host stack may be operated or executed on the same processing device within a processor module. The controller stack 526 may include a physical layer (PHY) 524, a link layer (LL) 522, and a host controller interface (HCI) 520. The physical layer (PHY) may operate to transmit and receive a 2.4 GHz wireless signal, using a Gaussian frequency shift keying (GFSK) modulation and a frequency hopping technique including forty RF channels. The link layer 522 may operate to transmit or receive a data packets, and may provide a function of generating a connection between devices after performing an advertising and scanning function using advertising channels, and exchanging data packets of a maximum byte size through data channels. The HCI 520 may operate to handle the interface between the host stack 504 and the controller stack 526.

The host stack 504 may include a generic access profile (GAP) 506, a logical link control and adaptation protocol (L2CAP) 518, a security manager (SM) 516, an attribute protocol (ATT) 514, and a generic attribute profile (GATT) 508. In other examples, the host stack 504 may include various protocols and profiles. The L2CAP 518 may operate to encapsulate data from the BLE higher layers into a standard BLE packet format for transmission, or may operate to extract data from a standard BLE packet format on reception. The ATT 514 may operate to transfer attribute data between clients and servers in GATT-based profiles. The ATT 514, for example, may define the roles of the client-server architecture. The GATT 508 may provide a reference framework for GATT-based profiles. The GATT 508 may encapsulate the ATT 514, and may be responsible for coordinating the exchange of profiles in a BLE link. The SM 516 may operate to apply security algorithms to encrypt and decrypt data packets. The GAP 506 may specify roles, modes, and procedures of a device, and manage connection establishment and security.

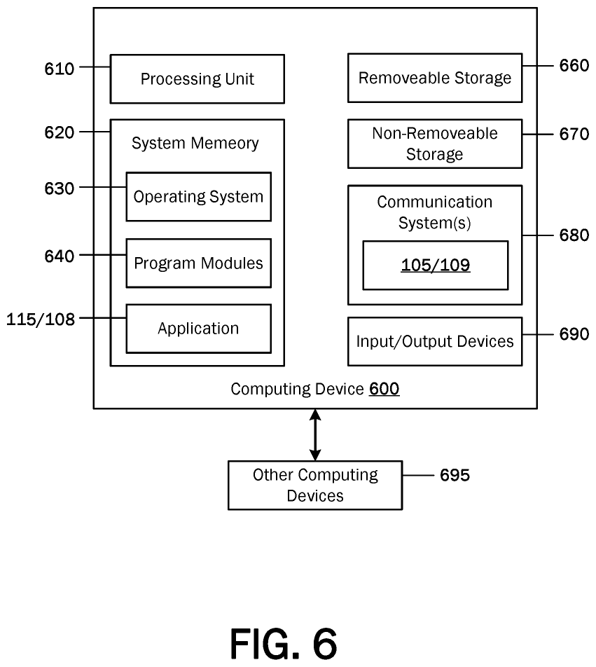

FIG. 6 is a system diagram of a computing device 600 according to an example. The computing device 600, or various components and systems of the computing device 600, may be integrated or associated with the customer device 104, the mobile device 106, and/or the application server 112. As shown in FIG. 6, the physical components (e.g., hardware) of the computing device 600 are illustrated and these physical components may be used to practice the various aspects of the present disclosure.

The computing device 600 may include at least one processing unit 610 and a system memory 620. The system memory 620 may include, but is not limited to, volatile storage (e.g., random access memory), non-volatile storage (e.g., read-only memory), flash memory, or any combination of such memories. The system memory 620 may also include an operating system 630 that controls the operation of the computing device 600 and one or more program modules 640. A number of different program modules 640 and data files may be stored in the system memory 620. While executing on the processing unit 610, the program modules 640 may perform the various processes described above. One example program module 640 may include the customer device application 115 or the mobile device application 108 described above.

The computing device 600 may also have additional features or functionality. For example, the computing device 600 may include additional data storage devices (e.g., removable and/or non-removable storage devices) such as, for example, magnetic disks, optical disks, or tape. These additional storage devices are labeled as a removable storage 660 and a non-removable storage 670.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 600 on the single integrated circuit (chip). The disclosure may also be practiced using other technologies capable of performing logical operations such as, for example, AND, OR, and NOT, including but not limited to mechanical, optical, fluidic, and quantum technologies.

The computing device 600 may include one or more communication systems 680 that enable the computing device 600 to communicate with other computing devices 695 such as, for example, routing engines, gateways, signing systems and the like. Examples of communication systems 680 include, but are not limited to, the mobile device communication system 109 or the customer device communication system 105 described above, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 600 may also have one or more input devices and/or one or more output devices shown as input/output devices 690. These input/output devices 690 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 620, the removable storage 660, and the non-removable storage 670 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal and may comprise tangible, non-transitory computer storage media.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for providing remote servicing of a customer device over a secure short-range wireless communication network connection, comprising:
advertising, by the customer device, a unique identifier of the customer device over a short-range wireless communication network;
receiving a request from a mobile device to initiate a connection to the customer device;
in response to the request, exchanging pairing information with the mobile device;
based on the pairing information, establishing a secure connection between the mobile device and the customer device; and
performing an authentication method over the secure connection, comprising:
deriving a public key;
advertising the public key to the mobile device;
deriving a first authentication key using the public key, a stored private key, and the unique identifier of the customer device;
receiving a second authentication key from the mobile device; and
in response to determining that the first authentication key and the second authentication key match, allowing the mobile device read, write, or read-and-write access to a plurality of attributes in a storage system on the customer device related to servicing the customer device via the mobile device over the secure connection.

2. The method of claim 1, wherein advertising the unique identifier comprises advertising a serial number of the customer device.

3. The method of claim 1, wherein:
advertising the unique identifier of the customer device is in association with advertising a first service of one or more services provided by the customer device, wherein the first service includes one or more attributes of the plurality of attributes;
receiving the second authentication key comprises receiving, in a first writable attribute of the plurality of attributes included in the first service, a first value including the second authentication key; and
in response to determining that the first authentication key and the second authentication key match:
writing a portion of the first value to the first attribute; and
allowing the mobile device read, write, or read-and-write access to the plurality of attributes included in the first service via the secure connection.

4. The method of claim 3, wherein advertising the first service comprises:
advertising the first service at a first advertising rate for a predetermined duration; and
after the predetermined duration, in response to not receiving the request from the mobile device to initiate a connection, advertising the first service at a second advertising rate, wherein the first advertising rate is more frequent than the second advertising rate.

5. The method of claim 3, wherein writing the portion of the first value to the first attribute comprises:
converting a user identifier included in the first value from a hexadecimal format to text format; and
writing the user identifier in the text format to a user identifier attribute included in the plurality of attributes.

6. The method of claim 3, further comprising, after allowing the mobile device read, write, or read-and-write access to the plurality of attributes included in the first service, advertising one or more of the one or more services, including the unique identifier of the customer device in advertisements of the one or more services.

7. The method of claim 1, wherein deriving the public key comprises repeatedly deriving a new public key according to a predetermined frequency.

8. The method of claim 1, wherein deriving the public key comprises including one or more digits in the public key that indicate a version of the stored private key.

9. The method of claim 1, wherein deriving the first authentication key comprises:
concatenating the unique identifier of the customer device, the public key, and the stored private key;
inputting the concatenation into a hashing algorithm; and
truncating a resulting hash to a predetermined number of characters.

10. The method of claim 1, further comprising:
in response to receiving a read request from the mobile device for an attribute of the plurality of attributes, providing a value of the attribute; and
in response to receiving a write request from the mobile device for an attribute of the plurality of attributes, writing the value to the attribute.

11. A method for providing remote servicing of a customer device over a secure short-range wireless communication network connection, comprising:
authenticating a user of a mobile device;
obtaining a private key for the customer device via a first communication network;
receiving an advertisement from the customer device over a second communication network, wherein the advertisement includes a unique identifier of the device;
in response to identifying the customer device based on the unique identifier, initiating a connection to the customer device over the second communication channel;
exchanging pairing information with the customer device;
based on the pairing information, establishing a secure connection between the mobile device and the customer device; and
performing an authentication method over the secure connection, comprising:
receiving a public key from the customer device;
deriving a first authentication key using the public key, the unique identifier, and the private key;
providing the first authentication key to the customer device; and
receiving read, write, or read-and-write access to a plurality of attributes in a storage system on the customer device, wherein the plurality of attributes is related to servicing the customer device via the mobile device via the secure connection.

12. The method of claim 11, wherein deriving the first authentication key comprises:
generating a concatenation of the unique identifier of the customer device, the public key, and the stored private key;
inputting the concatenation into a hashing algorithm; and
truncating a resulting hash to a predetermined number of characters.

13. The method of claim 11, wherein identifying the customer device comprises:
receiving the unique identifier of the customer device in a list of one or more customer devices scheduled for servicing; and
determining the unique identifier included in the advertisement matches the unique identifier of the customer device in the list.

14. The method of claim 13, further comprising:
receiving location information of the customer device in the list; and
determining the location matches an approximate location of where the advertisement is received.

15. The method of claim 13, wherein obtaining the private key comprises:
in a request to a server, including the unique identifier of the customer device in the list and a user identifier of the user of the mobile device; and
in response to being authorized and authenticated by the server, receiving the private key.

16. The method of claim 13, wherein:
receiving the advertisement comprises receiving an advertisement of a first service of one or more services included in the database, wherein the first service includes a plurality of attributes corresponding to at least a portion of the plurality of attributes in the storage system; and
providing the first authentication key comprises requesting to write a first value including the authentication key to a first writable attribute of the plurality of attributes included in the first service.

17. A customer device permitting remote servicing of the customer device over a secure short-range wireless communication network connection, the customer device comprising:
at least one processor;
memory, operatively connected to the at least one processor and storing instructions that, when executed by the at least one processor, cause the customer device to:
advertise a unique identifier of the customer device over a short-range wireless communication network;
receive a request from a mobile device to initiate a connection;
in response to the request, exchange pairing information with the mobile device, comprising at least one of:
indicating support for secure connections;
indicating a requirement for man-in-the-middle (MITM) protection;
indicating capability for out of band (OOB) authentication information reception; and
indicating the customer device does not have input or output capabilities for authentication;
based on the pairing information, establish a secure connection between the mobile device and the customer device; and
perform an authentication method over the secure connection, comprising:
deriving a public key;
advertising the public key to the mobile device;
deriving a first authentication key using the public key, a stored private key received OOB, and the unique identifier of the customer device;
receiving a second authentication key from the mobile device; and
in response to determining that the first authentication key and the second authentication key match, allowing the mobile device read, write, or read-and-write access to a plurality of attributes in a storage system on the customer device related to servicing the customer device via the mobile device over the secure connection.

18. The customer device of claim 17, wherein in advertising the unique identifier, the communication network is operative to advertise the unique identifier of the customer device in association with a first service of one or more services included in a profile stored in the storage system, wherein the first service includes a plurality of attributes corresponding to at least a portion of the plurality of attributes of the customer device.

19. The customer device of claim 18, wherein in receiving the second authentication key, the communication network is operative to:
receive a request to write a first value in a first writable attribute of the plurality of attributes included in the first service, wherein the first value includes the second authentication key;
extract the second authentication key from the first value; and
in response to determining that the first authentication key and the second authentication key match:
write a remaining portion of the first value to the first attribute; and
allow the mobile device read, write, or read-and-write access to the plurality of attributes included in the first service via the secure connection.

20. The customer device of claim 18, wherein:
the first service includes attributes corresponding to information about the customer device, wherein the customer device is a network access device;
a second service of the one or more services includes attributes corresponding to performing one or more troubleshooting operations; and
a third service of the one or more services includes attributes corresponding to information about access to a network to which the network access device is connected, wherein the network is not the short-range wireless communication network.
